(19) United States
(12) Patent Application Publication
(10) Pub. No.: US 2026/0188709 A1
(43) Pub. Date: Jul. 2, 2026

(54) FUEL CELL

(71) Applicant: TOYOTA JIDOSHA KABUSHIKI KAISHA, Toyota-shi (JP)

(72) Inventor: Ayuka OHTA MATSUGAMI, Toyota-shi (JP)

(73) Assignee: TOYOTA JIDOSHA KABUSHIKI KAISHA, Toyota-shi (JP)

(21) Appl. No.: 19/387,257

(22) Filed: Nov. 12, 2025

(30) Foreign Application Priority Data
Dec. 26, 2024 (JP) 2024-230554

(51) Int. Cl. H01M 8/0258

(52) U.S. Cl. CPC H01M 8/0258

(57) ABSTRACT

A fuel cell is provided that includes: a power generating portion including an electrolyte membrane and a pair of electrode layers sandwiching the electrolyte membrane; a pair of separators sandwiching the power generating portion; a gas channel interposed between the power generating portion and at least one of the separators; and at least one capillary channel configured to transfer product water by capillary action from a first region toward a second region. The first region is a region near a gas discharge port configured to discharge gas from the gas channel. The second region is a region near a gas supply port configured to supply the gas to the gas channel.

### CROSS-REFERENCE TO RELATED APPLICATION

This application claims priority to Japanese Patent Application No. 2024-230554 filed on Dec. 26, 2024. The disclosure of the above-identified application, including the specification, drawings, and claims, is incorporated by reference herein in its entirety.

### BACKGROUND

### 1. Technical Field

The present disclosure relates to fuel cells.

### 2. Description of Related Art

For example, a fuel cell stack such as a polymer electrolyte fuel cell (PEFC) stack is formed by stacking power generating portions with separators interposed therebetween. Each power generating portion is a membrane electrode and gas diffusion layer assembly (MEGA) in which a polymer electrolyte membrane is sandwiched between an anode and a cathode. In this type of fuel cell stack, power generation performance can be improved by keeping the polymer electrolyte membranes in an appropriate humidified state so as to suppress dry-out.

One technique for suppressing dry-out of the polymer electrolyte membranes is to use a humidifier (Japanese Unexamined Patent Application Publication No. 2015-210871 (JP 2015-210871 A)).

### SUMMARY

However, there is demand for a technique that can suppress dry-out without using an additional device such as a humidifier.

The present disclosure provides a technique that suppresses dry-out of components such as an electrolyte membrane and gas diffusion layers by using product water produced in a fuel cell.

The disclosure of the present specification is embodied in a fuel cell. The fuel cell includes: a power generating portion including an electrolyte membrane and a pair of electrode layers sandwiching the electrolyte membrane; a pair of separators sandwiching the power generating portion; and a gas channel interposed between the power generating portion and at least one of the separators. The fuel cell further includes at least one capillary channel configured to transfer product water by capillary action from a first region toward a second region. The first region is a region near a gas discharge port configured to discharge gas from the gas channel. The second region is a region near a gas supply port configured to supply the gas to the gas channel.

In this fuel cell, the product water can be transported by capillary action from the first region to the second region. Since the product water is transferred to the second region, the product water can humidify the gas in the second region. The humidified gas flows through the gas channel. As a result, dry-out of the electrolyte membrane etc. in contact with the gas channel is effectively suppressed without using external humidifying means.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a perspective view showing an example of a capillary channel in a fuel cell;

FIG. 1B is a sectional view taken along line 1B-1B in FIG. 1A;

FIG. 2A is an exploded perspective view showing another example of the configuration of the capillary channel in the fuel cell;

FIG. 2B is an exploded perspective view showing still another example of the configuration of the capillary channel in the fuel cell;

FIG. 2C is an exploded perspective view showing yet another example of the configuration of the capillary channels in the fuel cell;

FIG. 3A is a diagram showing a further example of the configuration of the capillary channel in the fuel cell;

FIG. 3B is a diagram showing a still further example of the configuration of the capillary channel in the fuel cell;

FIG. 3C is a diagram showing a yet further example of the configuration of the capillary channel in the fuel cell; and

FIG. 3D is a diagram showing a yet further example of the configuration of the capillary channel in the fuel cell.

### DETAILED DESCRIPTION OF EMBODIMENTS

The fuel cell disclosed in the present specification may include the following aspects in addition to the aspect described above.

In another aspect of the fuel cell, the first region is disposed below the second region in the direction of gravity. Since product water tends to accumulate in the first region located lower in the direction of gravity, it is useful to transfer such product water to the second region through the capillary channel.

In still another aspect of the fuel cell, the at least one capillary channel includes, in series, a first capillary channel having a first cross-sectional area and a second capillary channel having a second cross-sectional area smaller than the first cross-sectional area, the first capillary channel is disposed in the first region of the at least one capillary channel, and the second capillary channel is disposed in the second region of the at least one capillary channel. This configuration makes it easier to transfer the product water from the first region to the second region through the capillary channel by capillary action.

In yet another aspect of the fuel cell, the first cross-sectional area is 0.1 mm² or more and 0.3 mm² or less, and the second cross-sectional area is less than 0.1 mm². This configuration makes it possible to transfer the product water over a sufficient distance (e.g., a total of 150 mm or more).

In a further aspect of the fuel cell, the length of the first capillary channel is 20 mm or more, and the length of the second capillary channel is 40 mm or more. This configuration makes it possible to effectively capture the product water in the first region and increase the pressure loss in the second capillary channel, thereby suppressing backflow of the product water due to the gas flow.

In a still further aspect of the fuel cell, the fuel cell includes at least part of the at least one capillary channel in one or more of the electrolyte membrane, the electrode layer, and the separator. By using part of the elements of the fuel cell, the fuel cell can be effectively humidified.

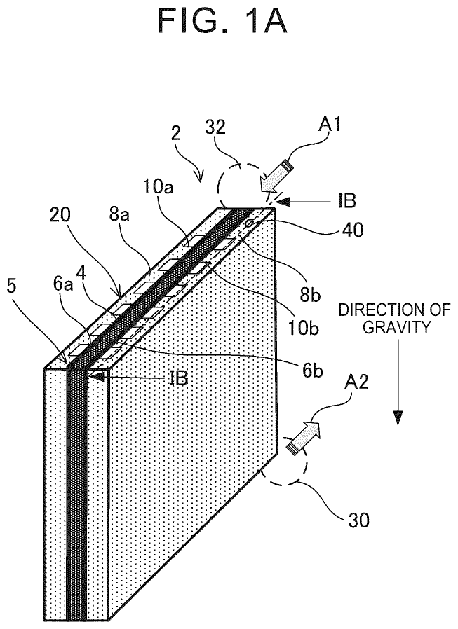

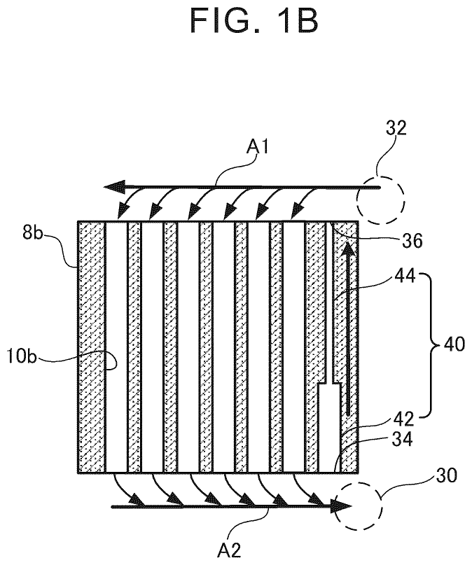

Hereinafter, the fuel cell disclosed in the present specification will be described with reference to the drawings as appropriate. FIG. 1A is a perspective view of a power generating portion 20 of a polymer electrolyte fuel cell (PEFC) 2 (hereinafter simply referred to as “cell”), and FIG. 1B is a sectional view taken along line IB-IB in FIG. 1A.

FIG. 1A shows the power generating portion 20 of the cell 2. As shown in FIG. 1A, the cell 2 includes an electrolyte membrane 4, a pair of electrode layers 6a, 6b serving as an anode and a cathode, and separators 8a, 8b. The electrolyte membrane 4 and the electrode layers 6a, 6b may form a membrane electrode assembly (MEA) 5. Between the MEA 5 and the separators 8a, 8b, gas channels 10a for a fuel gas such as hydrogen and gas channels 10b for an oxidant gas such as air or oxygen are formed by protrusions and recesses of the separators 8a, 8b. A gas diffusion layer (GDL) may also be provided on the electrode layers 6a, 6b. In that case, the electrolyte membrane 4 and the electrode layers 6a, 6b together with the gas diffusion layers may form a membrane electrode and gas diffusion layer assembly (MEGA).

As shown in FIGS. 1A and 1B, in the power generating portion 20, the gas channels 10a, 10b supply the fuel gas and the oxidant gas to the electrode layers 6a, 6b, respectively. For example, a gas supply passage and a gas discharge passage (not shown) are connected to the gas channels 10b of the cell 2.

As a result, in the power generating portion 20, as shown in, for example, FIGS. 1A and 1B, an oxidant gas A1 is supplied from a gas supply site 32 located at one side of the power generating portion 20 in the direction in which the gas channels 10b are arranged in parallel. That is, the oxidant gas A1 is supplied to the gas channels 10b through the gas supply site 32. In addition, an oxidant gas A2 having passed through the power generating portion 20 is discharged from a gas discharge site 30 located below the gas supply site 32 in the direction of gravity. That is, the oxidant gas A2 is discharged from the gas channels 10b through the gas discharge site 30. The gas discharge site 30 and the gas supply site 32 are examples of the first region and the second region in the present specification, respectively.

As shown in FIGS. 1A and 1B, the cell 2 is provided with a capillary channel 40. As shown in FIG. 1A, the capillary channel 40 is formed within the thickness of the separator 8b. The capillary channel 40 is configured to transfer product water from the gas discharge site 30 toward the gas supply site 32 by capillary action.

As shown in FIG. 1B, the capillary channel 40 directly connects the gas discharge site 30 and the gas supply site 32. Specifically, the capillary channel 40 has an opening 34 that opens at the gas discharge site 30 and an opening 36 that opens at the gas supply site 32. The capillary channel 40 connects these openings. The configuration of the capillary channel 40 is not particularly limited. For example, in a dense matrix such as the separator 8b, the capillary channel 40 may be provided as an elongated through passage.

As shown in FIG. 1B, the capillary channel 40 includes, in series, a first capillary channel 42 having a large diameter and a second capillary channel 44 having a diameter smaller than that of the first capillary channel 42. The first capillary channel 42 is formed near the gas discharge site 30 and has a relatively large cross-sectional area so as to readily draw up product water. The cross-sectional area of the first capillary channel 42 is not particularly limited, but may be, for example, 0.1 mm² or more and 0.3 mm² or less. A cross-sectional area in this range is considered to allow product water to be drawn up (transferred) by about 50 mm to 100 mm. The length of the first capillary channel 42 is not particularly limited, but in view of the expected amount of product water and degree of humidification, it may be, for example, 20 mm or more. This length is set as appropriate according to the intended extent of product water transfer.

The cross-sectional area of the second capillary channel 44 is not particularly limited, but may be, for example, less than 0.1 mm². A cross-sectional area in this range is considered to allow product water to be drawn up (transferred) by 100 mm or more. The length of the second capillary channel 44 is not particularly limited, but in view of the expected amount of product water and degree of humidification, it may be, for example, 20 mm or more. This length is set as appropriate according to the intended extent of product water transfer. The length of the second capillary channel 44 may preferably be 40 mm or more. When the length is 40 mm or more, the pressure loss in the second capillary channel 44 at the gas supply site 32 increases, thereby making it less likely for gas to flow into the second capillary channel 44 and suppressing backflow of the product water.

The cross-sectional shapes of the first capillary channel 42 and the second capillary channel 44 are not particularly limited.

Providing the capillary channel 40 allows product water at the gas discharge site 30 to be captured, drawn up, and transferred to the gas supply site 32. The product water having reached the gas supply site 32 humidifies the oxidant gas A1, and the humidified oxidant gas A1 then flows through the gas channels 10b. As a result, the electrode layer 6b and the electrolyte membrane 4 that are in contact with the gas channels 10b can be humidified. When the cell 2 is provided with gas diffusion layers, the gas diffusion layers can also be humidified.

Since the gas discharge site 30 is located below the gas supply site 32 in the direction of gravity, the capillary channel 40 can effectively use product water that tends to accumulate in the lower position in the direction of gravity for humidification. Since the capillary channel 40 transfers product water by capillary action, the positional relationship between the gas discharge site 30 and the gas supply site 32 can be set independently of the direction of gravity.

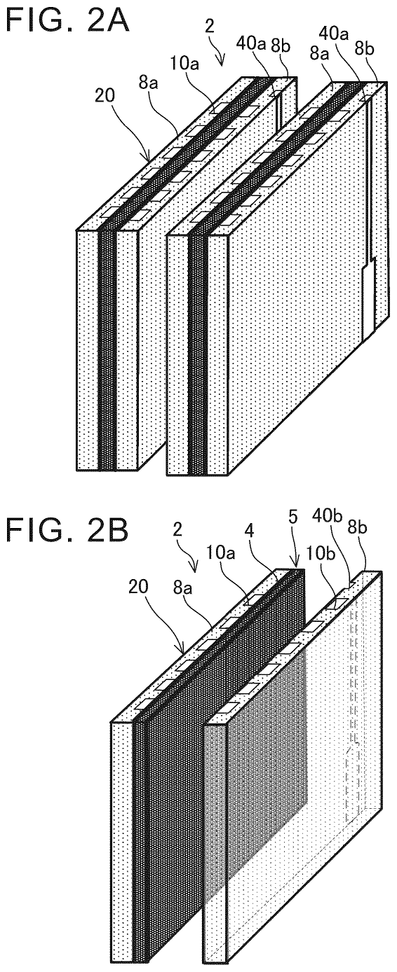

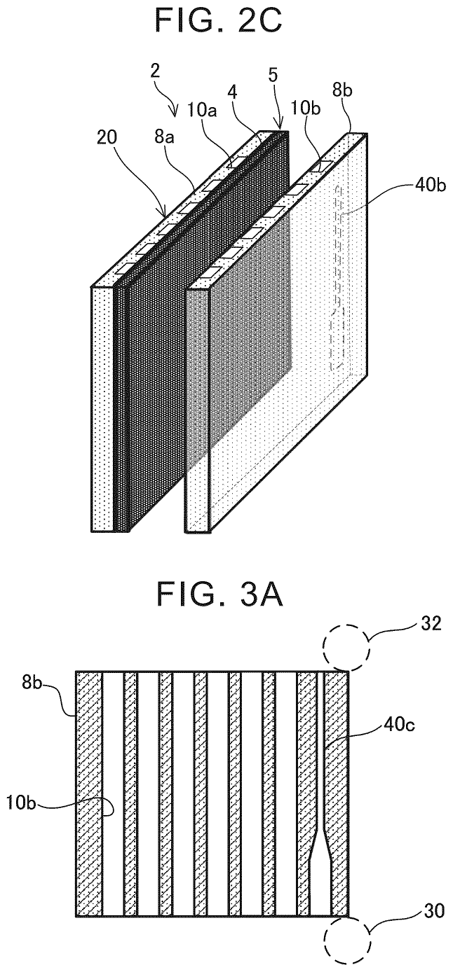

Since the capillary channel 40 is formed within the thickness of the separator 8b, the position of the capillary channel 40 can be set with great flexibility. As shown in FIG. 2A, a capillary channel 40a may be provided by forming a recess in the separator 8b of the cell 2 and sealing the recess with the separator 8a of an adjacent cell 2 or with a sealing gasket, rather than being provided inside the separator 8b.

As shown in FIG. 2B, a capillary channel 40b may be formed in part by the MEA 5 including the electrolyte membrane 4 and the electrode layer 6b. For example, the capillary channel 40b may be formed as a recess in the separator 8b facing the MEA 5, and the recess may be sealed by the MEA 5. In this way, the product water transferred from the gas discharge site 30 can be diffused into the electrolyte membrane 4, the electrode layer 6b, etc. before reaching the gas supply site 32, thereby providing humidification.

Furthermore, when part of the capillary channel 40b is formed by the MEA 5 including the electrolyte membrane 4 and the electrode layer 6b, the capillary channel 40b may not open at the gas discharge site 30 or the gas supply site 32, as shown in FIG. 2C. The product water can diffuse through the electrolyte membrane 4, the electrode layer 6b, etc. Accordingly, even though the capillary channel 40b is not connected to the gas supply site 32 or the gas discharge site 30, product water contained within the electrolyte membrane 4 etc. near the gas discharge site 30 can be transferred to the electrolyte membrane 4 etc. near the gas supply site 32.

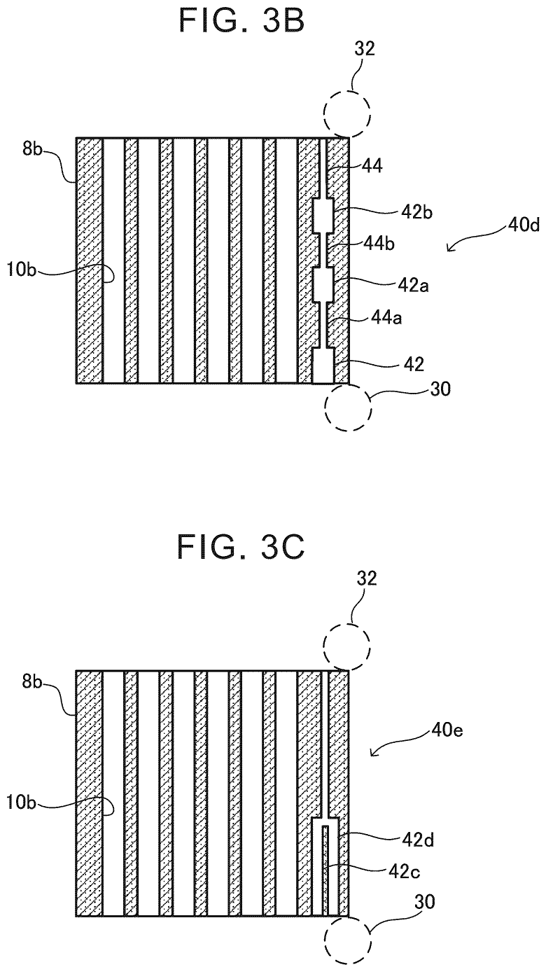

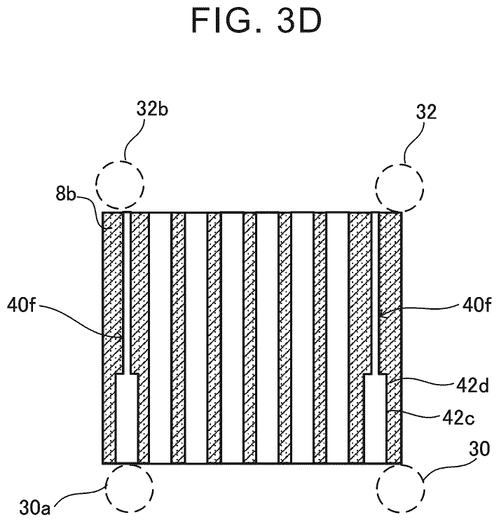

Since the first capillary channel 42 and the second capillary channel 44 of the capillary channel 40 have different cross-sectional areas at the gas discharge site 30 and the gas supply site 32, product water can be effectively captured and transferred. As shown in FIG. 3A, a capillary channel 40c may directly connect the first capillary channel 42 and the second capillary channel 44 having different cross-sectional areas, but may instead include a connecting portion in which the cross-sectional area gradually changes between the first capillary channel 42 and the second capillary channel 44. This facilitates smooth transfer of the product water.

As shown in FIG. 3B, a capillary channel 40d may include one or two or more additional first capillary channels 42a, 42b and one or two or more additional second capillary channels 44a, 44b between the first capillary channel 42 and the second capillary channel 44. This may allow a large amount of product water to be transferred. In this case, the total length of the first capillary channels 42 is preferably 20 mm or more, and the total length of the second capillary channels 44 is preferably 40 mm or more. The first capillary channels 42a, 42b, etc. of the capillary channel 40d with such a configuration may be formed so as to extend into the MEA 5 such as the electrolyte membrane 4 and the electrode layer 6b. In this case, the product water in the capillary channel 40 can diffuse into the electrolyte membrane 4, the electrode layer 6b, etc. through the first capillary channels 42a, 42b before reaching the gas supply site 32.

As shown in FIG. 3C, a capillary channel 40e may include a plurality of first capillary channels 42c, 42d arranged in parallel. This may allow the product water near the gas discharge site 30 to be effectively captured.

As shown in FIG. 3D, the cell 2 may be provided with a plurality of capillary channels 40f. This allows product water to be transferred from another gas discharge site 30a toward another gas supply site 32a through the gas channels 10b.

In the above description, the gas channels 10b for the oxidant gas A1 provided in the cell 2 have been described. However, the same capillary channel configurations as those described above may be provided for the fuel gas channels 10a.

The above description illustrates an example in which a plurality of oxidant gas channels 10b is provided. However, the present disclosure is not limited to this. The gas channels 10b may be provided in various patterns.

The disclosure of the specification includes the following aspects.
(1) A fuel cell including:
a power generating portion including an electrolyte membrane and a pair of electrode layers sandwiching the electrolyte membrane;
a pair of separators sandwiching the power generating portion;
a gas channel interposed between the power generating portion and at least one of the separators; and
at least one capillary channel configured to transfer product water by capillary action from a first region toward a second region, the first region being a region near a gas discharge port configured to discharge gas from the gas channel, and the second region being a region near a gas supply port configured to supply the gas to the gas channel.
(2) The fuel cell according to (1), wherein the first region is disposed below the second region in the direction of gravity.
(3) The fuel cell according to (1) or (2), wherein the at least one capillary channel includes, in series, a first capillary channel having a first cross-sectional area and a second capillary channel having a second cross-sectional area smaller than the first cross-sectional area, and the first capillary channel is disposed in the first region of the at least one capillary channel, and the second capillary channel is disposed in the second region of the at least one capillary channel.
(4) The fuel cell according to (3), wherein the first cross-sectional area is 0.1 mm² or more and 0.3 mm² or less, and the second cross-sectional area is less than 0.1 mm².
(5) The fuel cell according to any one of (1) to (4), the length of the first capillary channel is 20 mm or more, and the length of the second capillary channel is 40 mm or more.
(6) The fuel cell according to any one of (1) to (5), wherein the fuel cell includes at least part of the at least one capillary channel in one or more of the electrolyte membrane, the electrode layer, and the separator.

Although the embodiments have been described in detail above, these are merely examples and are not intended to limit the scope of the claims. The technology set forth in the claims includes various modifications and variations of the specific examples illustrated above. The technical elements described herein or illustrated in the drawings exhibit their technical utility alone or in various combinations, and are not limited to the combinations set forth in the claims as filed. The technology described herein or illustrated in the drawings may simultaneously achieve a plurality of objects, and exhibit technical utility by achieving one of the objects.

What is claimed is:

1. A fuel cell comprising:
a power generating portion including an electrolyte membrane and a pair of electrode layers sandwiching the electrolyte membrane;
a pair of separators sandwiching the power generating portion;
a gas channel interposed between the power generating portion and at least one of the separators; and
at least one capillary channel configured to transfer product water by capillary action from a first region toward a second region, the first region being a region near a gas discharge port configured to discharge gas from the gas channel, and the second region being a region near a gas supply port configured to supply the gas to the gas channel.

2. The fuel cell according to claim 1, wherein the first region is disposed below the second region in a direction of gravity.

3. The fuel cell according to claim 2, wherein:
the at least one capillary channel includes, in series, a first capillary channel having a first cross-sectional area and a second capillary channel having a second cross-sectional area smaller than the first cross-sectional area, and
the first capillary channel is disposed in the first region of the at least one capillary channel, and the second capillary channel is disposed in the second region of the at least one capillary channel.

4. The fuel cell according to claim 3, wherein the first cross-sectional area is 0.1 mm² or more and 0.3 mm² or less, and the second cross-sectional area is less than 0.1mm².

5. The fuel cell according to claim 4, wherein a length of the first capillary channel is 20 mm or more, and a length of the second capillary channel is 40 mm or more.

6. The fuel cell according to claim 1, wherein the fuel cell includes at least part of the at least one capillary channel in one or more of the electrolyte membrane, the electrode layer, and the separator.
